(19) United States
(12) Patent Application Publication
(10) Pub. No.: US 2005/0012966 A1
(43) Pub. Date: Jan. 20, 2005

(54) Method for blocking unwanted facsimile transmissions

(76) Inventors: Shirley F. Mitchell, Lexington, KY (US); Brian K. Owens, Lexington, KY (US); Steven A. Rice, Shelbyville, KY (US); Douglas L. Robertson, Lexington, KY (US); Brandon R. Shields, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/620,202

(22) Filed: Jul. 14, 2003

(51) Int. Cl. H04N 1/00; H04N 1/32; H04M 11/00

(52) U.S. Cl. 358/440; 358/468; 358/437; 379/100.05

(57) ABSTRACT

A method for compiling, in a memory of a facsimile machine, at least one listing of telephone numbers or partial telephone numbers corresponding to authorized senders, or unauthorized senders, or both authorized and unauthorized senders. The method includes at least one of the following steps: 1) manually entering into the facsimile machine a code corresponding to a telephone number or partial telephone number to be added to the listing; or 2) manually entering into the facsimile machine a telephone number or partial telephone number to be added to the listing; or 3) causing the facsimile machine to scan machine readable data corresponding to a telephone number or partial telephone number to be added to the listing; or 4) manually selecting a telephone number or partial telephone number, or information corresponding to a telephone number or partial telephone number, displayed on a graphical display unit of the facsimile machine; or 5) sending an in-process signal while the facsimile machine is in the process of receiving or printing a facsimile from a sender, wherein the in-process signal causes a telephone number or partial telephone number of the sender to be added to the listing.

### TECHNICAL FIELD

The present invention is directed to a method for blocking unwanted facsimile transmissions, and more particularly, in one embodiment to a method for blocking unwanted facsimile transmissions by compiling a list of authorized and/or unauthorized senders.

### BACKGROUND

Facsimile machines are widely used by businesses and personal users for transmitting documents and other information. However, because facsimile machines may be able to be accessed by an outside party by simply calling the facsimile machine, undesired or unsolicited facsimile can be sent to such facsimile machines. These unsolicited or “junk” facsimiles utilize the resources (i.e., ink, paper, electricity, etc.) of the owner/operator of the facsimile machine and may prevent or delay the receipt of legitimate, desired facsimile transmissions.

Accordingly, there is a need for a method for blocking unwanted/unsolicited facsimile transmissions, as well as a need for a method for blocking facsimile transmissions which can be easily implemented.

### SUMMARY

In one embodiment, the invention is a method for blocking unwanted facsimile transmissions by compiling a list of telephone numbers or partial telephone numbers of authorized senders and/or a list of telephone numbers or partial telephone numbers of unauthorized senders. When a call is received from an unauthorized sender, the facsimile machine may block, refuse or terminate the attempted facsimile transmission. Various methods for compiling the list of authorized and unauthorized senders may be utilized.

In particular, in one embodiment, the invention is a method for blocking unwanted facsimile transmissions including the step of compiling at least one listing of telephone numbers or partial telephone numbers corresponding to authorized senders, or unauthorized senders, or both authorized and unauthorized senders. The compiling step includes at least one of the following steps: 1) manually entering a code corresponding to a telephone number or partial telephone number to be added to the listing; or 2) manually entering a telephone number or partial telephone number to be added to the listing; or 3) optically scanning machine readable data corresponding to a telephone number or partial telephone number to be added to the listing; or 4) manually selecting a telephone number or partial telephone number, or information corresponding to a telephone number or partial telephone number, displayed on a graphical display unit of a facsimile machine; or 5) sending an in-process signal while a facsimile machine is in the process of receiving or printing a facsimile transmission from a sender, wherein the in-process signal causes a telephone number or partial telephone number of the sender to be added to the listing. The method further includes the steps of receiving a signal indicative of a facsimile transmission from a potential transmitting sender, determining whether the potential transmitting sender is an authorized sender or determining whether the potential transmitting sender is not an authorized sender by referring to the listing, and if the transmitting sender is an unauthorized sender or is not an authorized sender, blocking, refusing or terminating the facsimile transmission.

In another embodiment, the invention is a method for compiling, in a memory of a facsimile machine, at least one listing of telephone numbers or partial telephone numbers corresponding to authorized senders, or unauthorized senders, or both authorized and unauthorized senders. The method includes at least one of the following steps: 1) manually entering into the facsimile machine a code corresponding to a telephone number or partial telephone number to be added to the listing; or 2) manually entering into the facsimile machine a telephone number or partial telephone number to be added to the listing; or 3) causing the facsimile machine to scan machine readable data corresponding to a telephone number or partial telephone number to be added to the listing; or 4) manually selecting a telephone number or partial telephone number, or information corresponding to a telephone number or partial telephone number, displayed on a graphical display unit of the facsimile machine; or 5) sending an in-process signal while the facsimile machine is in the process of receiving or printing a facsimile from a sender, wherein the in-process signal causes a telephone number or partial telephone number of the sender to be added to the listing.

In another embodiment the invention is a method for selectively blocking facsimile transmissions and includes the steps of receiving a proposed facsimile transmission from a sending device coupled to a telephone line and determining, or attempting to determine, a telephone number of the telephone line. The method further includes the step of, if the telephone number of the telephone line cannot be determined, blocking, refusing or terminating the proposed facsimile transmission.

In another embodiment the invention is a method for blocking unwanted facsimile transmissions including the steps of compiling at least one listing of partial telephone numbers and receiving a signal indicative of a facsimile transmission from a potential transmitting sender. The method further includes the step of determining whether the potential transmitting sender is an authorized sender or determining whether the potential transmitting sender is not an authorized sender by referring to the listing, and if the transmitting sender is an unauthorized sender or is not an authorized sender, blocking, refusing or terminating the facsimile transmission.

Other objects and advantages of the present invention will be apparent from the following description and the accompanying drawings.

### BRIEF DESCRIPTION OF THE DRAWINGS

FIG. 1 is a front perspective view of a facsimile machine which may include the facsimile blocking method/system of the present invention;

FIG. 2 is a block diagram illustrating various components of the facsimile machine of FIG. 1;

FIG. 3 is diagrammatic illustration of various manners in which a call block/call permit list may be compiled;

FIG. 4 is an illustrative example of a log which may be used to compile call block/call permit list; and

FIG. 5 is a flow chart illustrating a procedure for handling incoming facsimile transmissions using the method of the present invention.

### DETAILED DESCRIPTION

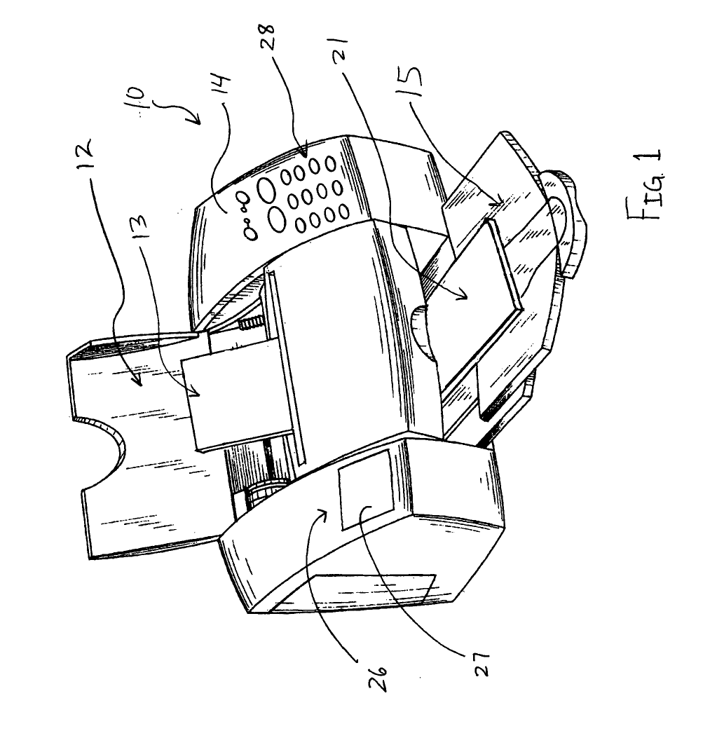

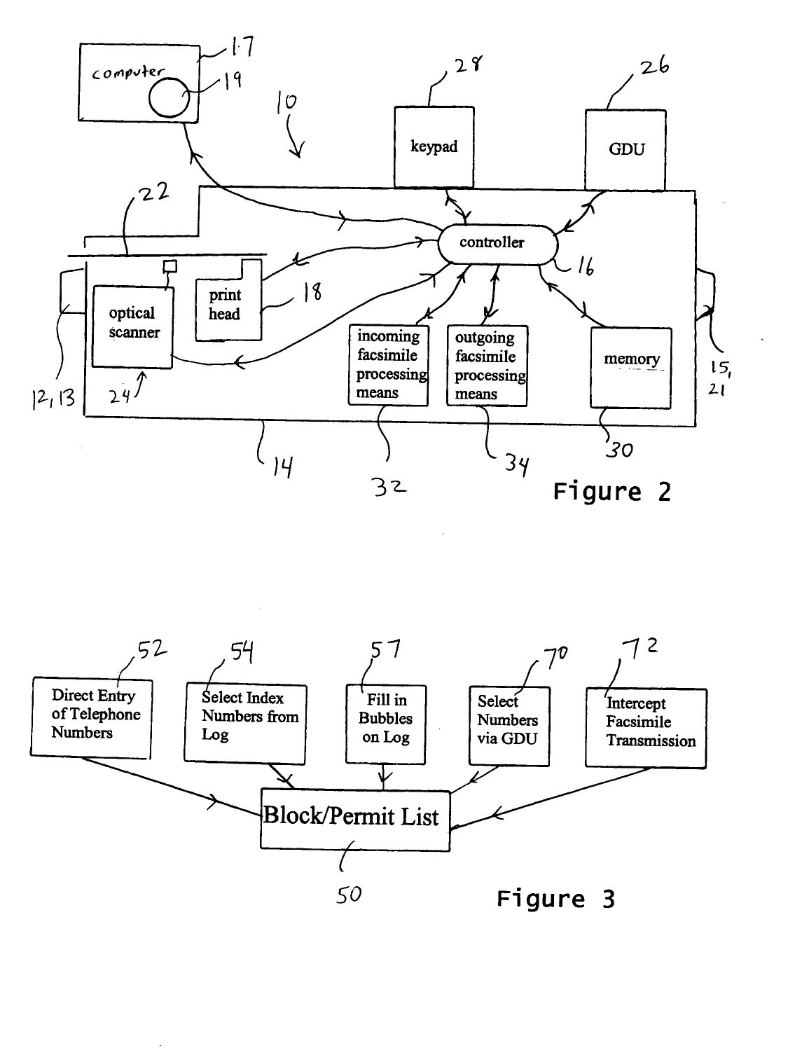

The present invention may be implemented in, and/or include, a facsimile machine for receiving facsimile transmittals. In one embodiment, the facsimile device 10 is, includes, and/or is part of, a multifunction device such as, for example, a multifunction facsimile machine/copier/scanner/printer. In particular, as shown in FIGS. 1 and 2, the facsimile machine 10 may include a housing 14 which may house, store and/or support components of the facsimile machine 10. The facsimile machine 10 may include a controller, processor or CPU (hereinafter referred to as a controller 16), printing means, such as a print head 18, and scanning means such as an optical scanner 24. Both the print head 18 and optical scanner 24 may be operatively coupled to the controller 16. The controller 16 may include or be coupled to a memory 30 or a memory means. The memory 30 may be located in or part of the facsimile machine 10. Alternately, or in addition, the facsimile machine 10 may be coupled to a computer 17 which can include a memory 19.

The print head 18 may be able to print documents, text, photos, drawings, etc. onto various media. The data/print information provided to the print head 18 may be sent from a computer 17 to which the facsimile machine 10 is coupled, or from a received facsimile transmission, or from the optical scanner 24, or from an incoming facsimile processing means 32, from some other source. FIG. 2 schematically illustrates the print head 18 for printing on a document 22.

The optical scanner 24 may be able to determine visual properties of a document, and/or generate data or a data signal corresponding to the visual properties of a document. The data or data signal generated by the optical scanner 24 may then be sent to the controller 16 for further processing (i.e., printed out by the print head 18, sent to the computer 17, sent to another facsimile machine via outgoing facsimile transmission means 34, etc.). FIG. 2 schematically illustrates the optical scanner 24 for optically scanning the document 22. However, it should be understood that the optical scanner 24 and print head 18 may not necessarily operate on, or be able to operate on, on the same document 22 at the same time.

The facsimile machine 10 may include a print input tray 12 for storing paper or other media 22 to be printed upon by the print head 18 in the manner of a standard printer. The facsimile machine 10 may also include a print output tray 15 for storing papers, documents, or other media output by the facsimile machine 10 via the print input tray 12. The facsimile machine 10 may also include a scan/fax input tray 13 for storing paper, documents, or other media to be scanned or faxed (i.e. to be processed by the optical scanner 24). The facsimile machine 10 may also include a scan/fax output tray 21 for storing papers, documents, or other media scanned, printed or output from the facsimile machine 10 via the scan/fax input tray 13. However, if desired the facsimile machine 10 may also include only a single input tray and a single output tray.

As noted above, the facsimile machine 10 may have incoming facsimile processing means 32 which can receive and transmit facsimiles and facsimile transmissions in the standard manner by, for example, converting facsimile transmissions into print commands/data to be printed by the print head 18 and/or send to the controller 16 and/or computer 17. The facsimile machine 34 may also include outgoing facsimile processing means 34 so that the facsimile machine 10 can transmit facsimiles and facsimile transmission in the standard manner by, for example, converting optically scanned documents/data, and/or data supplied from the controller 16 and/or computer 17 into facsimile transmissions. Thus, the facsimile machine 10 may be able to scan a document (via the optical scanner 24) and send a copy, or data, relating to the scanned document to a computer 17 or to another facsimile machine. The facsimile machine 10 may be able to make copies of a scanned document, and the scanned/copied/faxed document may be sent to a computer or to another facsimile machine.

The computer 17 may also be able to receive, store, and block/accept facsimile transmissions. Thus, although the description below is directed to the example of a facsimile machine, the steps described below may also be able to be carried out by or in a computer 17 or other device capable of processing facsimile transmissions.

The facsimile machine 10 may include an interactive graphical display unit (“GDU”) or graphical user interface (“GUI”) 26 which can display and/or receive information, such as through a touch pad 27 that is responsive to pressure from a user. The facsimile machine 10 may also include a standard numerical or alphanumeric keypad 28. Both the GDU 26 and the keypad 28 may be located on, or integrated into, the housing 14, and may be coupled to the controller 16 so that inputs from a user can be sent to the controller 16 and the controller 16 can send outputs to the GDU 26 relating to the status of the facsimile machine 10.

In order to block the receipt of unwanted facsimiles, a list or lists of authorized and/or unauthorized users may be entered into the memory 30 or memory 19, and the list or lists may include a listing of telephone numbers or partial telephone numbers. In the case of a listing of unauthorized telephone numbers, a “call block” list may be generated such that when a facsimile transmission, or a potential or proposed facsimile transmission, is received from a telephone number listed on the call block list, action may be taken to block or refuse the facsimile transmission.

Correspondingly, a list of authorized senders (a “call permit list”) may also or alternatively be generated and stored in the memory 30 or memory 19. Under this scenario, a list of users or telephone numbers from whom facsimile transmissions will be accepted may be generated. In this case, only facsimile transmissions from telephone numbers on the call permit list may be processed (i.e., printed) while all other proposed facsimile transmissions may be refused, blocked or terminated. It should be understood that while the terms “call block list” and “call permit list” are used herein, the call block list and call permit list may also be considered “facsimile transmission block” and “facsimile transmission permit” lists, respectively.

Once the call block list and/or call permit list is compiled, the facsimile machine 10 may be operated to allow only those facsimile transmissions which are desired to be received to be processed by the facsimile machine 10. As noted above, the call block list may be used to block facsimile transmissions from undesired senders, and the call permit list may be used to allow only facsimile transmissions from desired senders. Accordingly, the call block list and call permit list may be used in different modes. For example, the facsimile machine 10 may be switched between a first mode in which the call block list blocks certain facsimile transmissions and allows all others, and a second mode wherein the call permit list allows certain facsimile transmissions but blocks all others. Alternately, the call block list and call permit list may be used in conjunction, or at the same time, in a third mode wherein calls from telephone numbers or senders which are on neither the call block list nor the call permit list may be analyzed under a separate set of criteria.

Various methods for handling proposed facsimile transmissions from unauthorized senders may be utilized. It should be understood that by “unauthorized senders,” it is meant telephone numbers or telephone stations from which facsimile transmissions originate, when such telephone numbers or part of such telephone numbers are either specifically listed on the call block list, or are not included on a call permit list, or both, or otherwise identified as unauthorized or undesired senders.

When a call is received from a sender's telephone station, the call is initiated by a ring signal. The call, or proposed facsimile transmission, may also include a transmit subscriber identification (“TSI”), also known as a message header, sent to the recipient's (or potential recipient's) telephone number and/or facsimile machine. The message header may include the sender's telephone number or other identifying information so that a user/receiver can identify the sender. The message header may be provided to the receiving party in various manners, for example, prior to acceptance of the transmission and/or after acceptance of the transmission.

Alternately, or in addition, the sender's telephone number or other identifying information may be identified by the telephone system/telephone company (i.e. the owner and/or operator of the telephone lines, telephone switching networks, etc.) and such information may accompany such call, by for example, a subscription service such as Caller ID. In this case, the sender's telephone number or other identifying information may be supplied to the recipient (or potential recipient) prior to receiving the transmission or prior to “answering” the call.

Thus, when a call from an unauthorized sender is received and the sender's telephone number is on the call block list (or is not on the call permit list), the recipient's facsimile machine may simply not answer the call. In other words, the facsimile machine may simply wait, or enter a timed loop, until the unauthorized sender terminates its call or its proposed transmission. Of course, the method may be used when the sender's telephone number or identifying information is provided prior to the recipient answering the call.

Alternately, the recipient's facsimile machine may take affirmative action by accepting the transmission and then immediately disconnecting the transmission (i.e., “picking up” and then immediately “hanging up.”) In this manner, the telephone call from the unauthorized sender is accepted and then quickly disconnected. This method may be used when the sender's telephone number or identifying information is provided either prior to or after the recipient answering the call.

Alternately, or in combination with the methods described above, the recipient's facsimile machine may respond to the proposed undesired facsimile transmission by sending out a “no service” tone. The “no service” tone may serve the dual purpose of terminating the call, as well as removing the recipient's telephone number from a call list used by an automatic dialer which may have initiated the call. This method may be used when the sender's telephone number or identifying information is provided either prior to or after the recipient answering the call.

Various methods of compiling the call block list and/or call permit list 50 may be utilized, some of which are outlined in FIG. 3. For example, in a first method or embodiment 52, a user may simply enter into the facsimile machine 10 or computer 17 a telephone number to be added to one of the listings. For example, a user may simply enter a 10-digit number (i.e., area code and telephone number) via the keypad 28 or the interactive graphical display unit 26 of the facsimile machine 10. The telephone numbers to be blocked or permitted may then be stored or added to the appropriate list in the memory 30 of the facsimile machine 10 or the memory 19 of the computer 17.

The facsimile machine 10 may have various methods to determine whether entered the telephone number is to be added to the call block or to the call permit list. For example, different buttons on the keypad 28 or a graphical display unit 26 may be able to be pressed such that the user can identify to which list the number should be added.

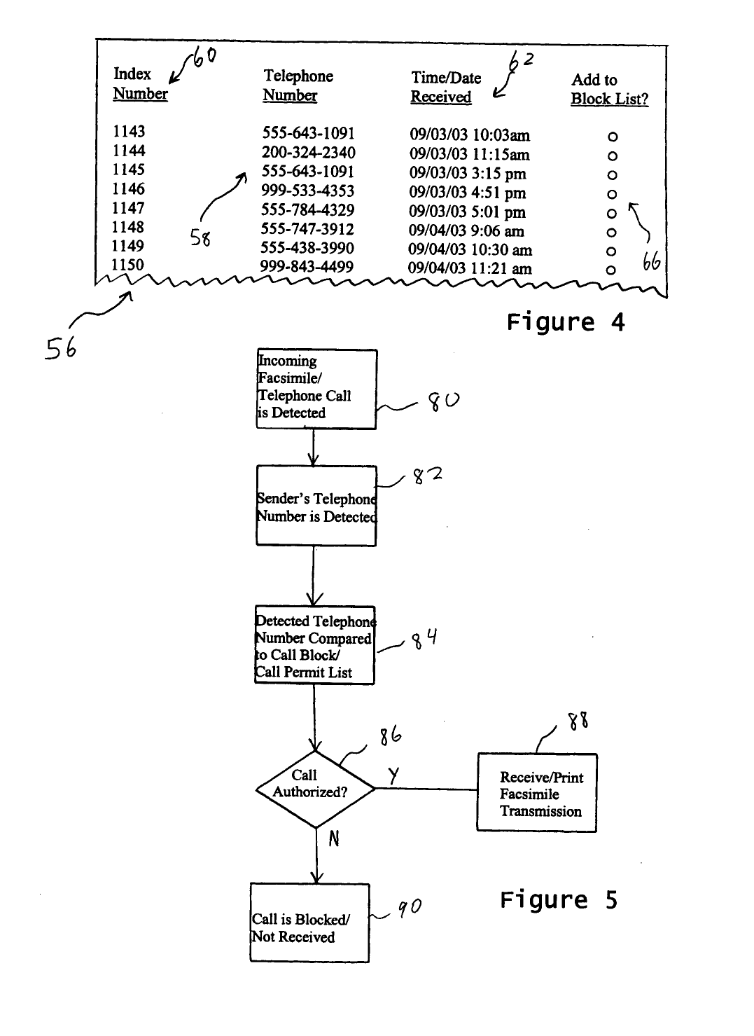

A second method or embodiment 54 for compiling a call block/permit list 50 includes causing the facsimile machine 10 or computer 17 to print out a listing or log 56 of telephone numbers 58 from which facsimiles have been received, along with an “index number” or code 60 corresponding to each listed telephone number. An example of such a log 56 is shown in FIG. 4. The index code 60 may be a unique identifier for each telephone number. The log 56 may also include a time/date stamp 62 (i.e., an indication of the time and date when each facsimile was received).

The log 56 may be printed out or generated at the request of a user, or may be printed out or generated at regular time intervals, or at other times or due to other causes. Once the log 56 is printed out, it may be presented to a user or users, who can then identify certain telephone numbers from which it is desired to block and/or receive facsimile numbers. For example, a user may recall a time and date at which a particular facsimile was received, and then using the time/date information identify the telephone number and corresponding index code. The index code or index number can then be entered into the computer 17 or facsimile machine (i.e., via the keypad 26 or interactive graphical display unit 28). The computer 17 or controller 16 of the facsimile machine 10 can then match the entered index number with the corresponding telephone number and add the number to the appropriate list.

A third method or embodiment 57 for compiling the call block list or call permit list 50 involves use of the log of FIG. 4 as described above. In particular, as shown in FIG. 4, the log 56 may include a column of “bubbles” 66 or other markable portions (such as, for example, a closed shape) corresponding to (i.e., in the illustrated embodiment, located adjacent to) each telephone number. In this manner, a user can fill in the bubble 66 of each number which is desired to be added to the appropriate list. For example, the log 56 of FIG. 4 includes a heading at the top of the column of bubbles 66 which indicates that the log 56 and bubbles 66 may be used to add telephone numbers to a call block list. However, it should be understood that a similar log could be used to add telephone numbers to a call permit list. Further, although FIG. 4 illustrates a log 56 which includes both index numbers 60 and “bubbles” 66 located thereon, it should be understood that the log 56 may also include only one of the index numbers 60 or bubbles 66.

The log 56, with the appropriate bubbles 66 filled in, may then scanned by the optical scanning component 24 of the facsimile machine 10 or some other component to determine which telephone numbers have been selected by the user to be added to the listing 50. In this manner, the facsimile machine 10 or computer 17 can scan or read the machine readable data corresponding to the telephone numbers to be added to the listings. The appropriate numbers can then be stored in the memory 30 of the facsimile machine 10 or the memory 19 of the computer 17.

In a fourth method or embodiment 70 for compiling the call block list and/or permit list 50, the user may interact with the graphical display unit 26 of the facsimile machine 10 to select the numbers to be added. In particular, the graphical display unit 26 may display a log similar to that of FIG. 4 so that the graphical display unit 26 displays telephone numbers and time/date stamp for received facsimiles. A user may then be able to scroll through the displayed telephone numbers to display different ones of the telephone numbers. For example, either the graphical display unit 26 or the keypad 28 may include up/down buttons, or buttons which can function in an up/down function to enable a user to scroll through the listing of telephone numbers and time/date stamps.

Furthermore, the graphical display unit 26 may include a mechanism or means for identifying selected ones of the telephone numbers. For example, at least one of the telephone numbers may be highlighted at any one time or identified with a cursor, pointer, etc. The user may then press a button (i.e., an “add” button) or otherwise send a signal that the highlighted or indicated telephone number should be added to the appropriate list.

A fifth method or embodiment 72 for adding telephone numbers to the call block list and/or call permit list 50 includes pressing a button on the facsimile machine 10 or computer 17 while the facsimile machine 10 is in the process of receiving and/or printing a facsimile from a sender. For example, if a user or operator of the facsimile machine 10 notes that the facsimile machine 10 is in the process of receiving and/or printing a junk or unwanted facsimile, the user may press an “add block” button to add the telephone number of the undesired sender to the call block list. Pressing the “add block” button may simultaneously cause the facsimile machine 10 or computer 17 to take steps to block or terminate further transmission or printing of the current facsimile from the undesired sender.

Alternately, if the user notes that the facsimile machine 10 is in the process of receiving and/or printing a facsimile from a desired sender, the user may press an “add permit” button to cause the telephone number of the sender to be added to the call permit list. Of course, various other methods, besides pressing a button, may be used to send such an “in process” signal to the controller 16 of the facsimile machine 10 to add the telephone number of the current transmission to one of the call block or call permit lists.

FIG. 5 illustrates a flowchart for implementing, in one embodiment, a method of the present invention. For example, the system may begin at block 80 for an incoming facsimile or telephone call (or proposed facsimile transmission) sent to the user's facsimile machine 10. At step 82, the telephone number of the sender is detected. For example, as noted above, the header of a proposed facsimile transmission may include a sender's telephone number that is transmitted along with each proposed facsimile transmission, or the sender's telephone number may be identified by Caller ID or by some other method or means.

At step 84, the detected telephone number of the sender is compared to at least one of the call block or call permit list. At decision step 86, the system splits depending upon whether the call is authorized. If the call is authorized, the system proceeds to step 88, wherein the facsimile transmission is received and/or printed. If, at step 86, it is determined that the call is not authorized, the system proceeds to step 90 and the call is blocked and/or not received in the manners discussed above.

Accordingly, the method of the present invention provides an easy method or means for blocking undesired facsimile transmissions. Furthermore, the various methods of compiling the call block list enable a user to quickly, easily and accurately add telephone numbers to the call block/call permit list.

In addition to blocking facsimile transmissions from telephone numbers which are on a call block/lacking from call permit list, the system/method of the present invention may block transmission from unidentified, or anonymous, or unknown senders. For example, if the header of the proposed facsimile transmission does not include a telephone number, or does not include a valid telephone number, than the facsimile machine may refuse/block/terminate the proposed transmission.

If desired, when the proposed facsimile transmission does not include a valid telephone number in its header, the facsimile machine may check the sender's telephone number by referring to Caller ID, and then determine whether to accept or decline the facsimile based upon the information provided by Caller ID. Alternately, the Caller ID information may be checked instead of the header information. If the Caller ID service does not provide a valid telephone number (including identifying the caller as “anonymous” or “out of area” or “unknown”) then the facsimile machine may refuse and/or block the proposed transmission. Thus, one or various methods for attempting to identify the sender may be utilized, and if the one or various methods are not successful than the call may be refused, blocked or terminated.

Furthermore, the call block/call permit list 50 may including listings or partial telephone numbers. For example, if an operator wishes to block/permit facsimile transmissions from a particular area code, then only that area code may be entered into the block/permit list, and all calls or facsimile transmissions from that area code may be blocked/permitted. Alternately, or in addition, calls from a particular area code (i.e. the first three numbers of a 10 digit telephone number) and a particular exchange (i.e. the next three digits of a 10 digit telephone number) may be desired to blocked/permitted. In this case, the area code and exchange from which calls are desired to be blocked/permitted may be added to the call block/permit list 50. Thus, partial listings of telephone numbers, or a fragment or part of telephone numbers, may be added to the call block/permit list 50.

Various ways of entering the partial telephone number to a call block/permit list 50 may utilized. In one embodiment, the keypad 28 and/or GUI 26 may include a button which can be pressed by a user to enter “wild card” characters. For example, when utilizing the first embodiment 52 for directly entering telephone numbers, when a user desires to block/permit telephone numbers from the 919 area code, and user may enter “919*******” via the keypad 28/GUI 26 wherein the “*” character represents a wild card. When a user desires to block/permit telephone numbers from the area code 919, having a 899 exchange, a user may enter “919899****”. The wild cards can act as place holders. Thus, in this embodiment a string of number may be added to the call block/permit and stored in the memory 19 or 30, and the string of numbers is compared to the first part of a telephone number of sender.

Furthermore, under the second embodiment 54 when a user enters an index number into the facsimile machine 10, the facsimile machine 10 may give the user the option to block all telephone calls/facsimile transmissions from the area code, or area/code exchange of the selected telephone number. The facsimile machine may also have this option when number are selected/identified in the first 52, third 57, fourth 70 and fifth 72 methods for adding numbers to a call block/call permit list.

When using the third embodiment 57 for adding numbers to the call block/permit list 50, the log 56 may have a bubble which can be filled out which provides an indication that the area code or area code and exchange of the selected number are to be added to the call block/call permit list. Of course, various other ways of adding telephone number fragments may also be utilized.

1. A method for blocking unwanted facsimile transmissions comprising the steps of:
compiling at least one listing of telephone numbers or partial telephone numbers corresponding to authorized senders, or unauthorized senders, or both authorized and unauthorized senders, wherein said compiling step includes at least one of the following steps:
1) manually entering a code corresponding to a telephone number or partial telephone number to be added to said listing; or
2) manually entering a telephone number or partial telephone number to be added to said listing; or
3) optically scanning machine readable data corresponding to a telephone number or partial telephone number to be added to said listing; or
4) manually selecting a telephone number or partial telephone number, or information corresponding to a telephone number or partial telephone number, displayed on a graphical display unit; or
5) sending an in-process signal while a facsimile machine is in the process of receiving or printing a facsimile transmission from a sender, wherein said in-process signal causes a telephone number or partial telephone number of said sender to be added to said listing;
receiving a signal indicative of a facsimile transmission from a potential transmitting sender;
determining whether said potential transmitting sender is an authorized sender or determining whether said potential transmitting sender is not an authorized sender by referring to said listing; and
if said transmitting sender is an unauthorized sender or is not an authorized sender, blocking, refusing or terminating the facsimile transmission.

2. The method of claim 1 wherein the method includes the step of causing said facsimile machine to print out a log of telephone numbers from which said facsimile transmission have been received, said log including information regarding when such facsimile transmissions were received.

3. The said method of claim 2 wherein said log includes a code corresponding to each printed telephone number which can be used in said first entering step.

4. The method of claim 2 wherein said log includes a plurality of markable portions, each markable portion corresponding to one of said printed telephone numbers, and wherein the method includes a user marking on selected ones of said markable portions to create said machine readable data.

5. The method of claim 4 wherein each markable portion is a closed shape.

6. The method of claim 1 wherein said facsimile machine includes said interactive graphical display unit, and wherein the method includes the step of displaying a log of telephone numbers from which facsimile transmission have been received and information regarding when such facsimile transmissions were received.

7. The method of claim 6 wherein said manually selecting step includes selecting a telephone number via said interactive graphical display unit.

8. The method of claim 7 wherein said manually selecting step includes confirming selection of a telephone number which is identified in said graphical display unit.

9. The method of claim 6 wherein said interactive graphical display unit is integrated into a housing of said facsimile machine.

10. The method of claim 6 wherein said interactive graphical display unit includes a touch pad configured to receive inputs from a user in response to manual pressure applied to said touch pad.

11. The method of claim 1 wherein said sending step includes a user pressing a button to send said in-process signal.

12. The method of claim 1 wherein the method further includes the step of, in response to said in-process signal, terminating the facsimile transmission from an undesired sender.

13. The method of claim 1 wherein the method further includes the step of, in response to said in-process signal, terminating the printing or receipt of a facsimile transmission that is being printed or received when said in-process signal is received.

14. The method of claim 1 wherein said blocking, refusing or terminating step includes connecting said facsimile machine to a telephone network and disconnecting said facsimile machine from said telephone network.

15. The method of claim 1 wherein said blocking, refusing or terminating step includes sending a disconnect signal that indicates that the telephone line to which said facsimile machine is coupled is disconnected.

16. The method of claim 1 wherein said blocking, refusing or terminating step includes failing to answer a telephone call from said proposed sender.

17. The method of claim 1 wherein said facsimile machine can be coupled to a computer to print documents in response to command and data signals from said computer, and wherein said facsimile machine can make copies of a scanned document.

18. The method of claim 1 wherein said at least one listing of telephone numbers or partial telephone numbers is compiled in a memory located in or part of a facsimile machine, and wherein said compiling, receiving and determining steps are carried out at or in said facsimile machine.

19. The method of claim 1 wherein said at least one listing of telephone numbers or partial telephone numbers is compiled in a memory located in or part of a computer to which a facsimile machine is operatively coupled, and wherein said receiving step is carried out at or in said facsimile machine.

20. The method of claim 1 wherein both of said manually entering steps and said optically scanning steps are carried out on said facsimile machine.

21. The method of claim 1 wherein said compiling step includes said first manually entering step, and does not include any of said second manually entering step, said optically scanning step, said manually selecting step, and said sending step.

22. The method of claim 1 wherein said compiling step includes said second manually entering step, and does not include any of said first manually entering step, said optically scanning step, said manually selecting step, and said sending step.

23. The method of claim 1 wherein said compiling step includes said optically scanning step, and does not include any of said first manually entering step, said second manually entering step, said manually selecting step, and said sending step.

24. The method of claim 1 wherein said compiling step includes said manually selecting step, and does not include any of said first manually entering step, said second manually entering step, said optically scanning step, and said sending step.

25. The method of claim 1 wherein said compiling step includes said sending step, and does not include any of said first manually entering step, said second manually entering step, said manually selecting step and said optically scanning step.

26. A method for blocking unwanted facsimile transmissions comprising the steps of:
compiling at least one listing of telephone numbers or partial telephone numbers corresponding to unauthorized senders, wherein said compiling step includes at least one of the following steps:
1) manually entering a code corresponding to a telephone number or partial telephone number to be added to said listing; or
2) manually entering a telephone number or partial telephone number to be added to said listing; or
3) causing said facsimile machine to scan machine readable data corresponding to a telephone number or partial telephone number to be added to said listing; or
4) manually selecting a telephone number or partial telephone number, or information corresponding to a telephone number or partial telephone number, displayed on a graphical display unit of said facsimile machine; or
5) sending a signal while said facsimile machine is in the process of receiving or printing a facsimile from an undesired sender, wherein said signal causes a telephone number or partial telephone number of said undesired sender to be added to said listing;
receiving a signal indicative of a facsimile transmission from a potential transmitting sender;
determining whether said potential transmitting sender is an unauthorized sender by referring to said listing; and
if said transmitting sender is an unauthorized sender blocking, refusing or terminating the facsimile transmission.

27. A method for compiling, in a memory of a facsimile machine, at least one listing of telephone numbers or partial telephone numbers corresponding to authorized senders, or unauthorized senders, or both authorized and unauthorized senders, wherein the method includes at least one of the following steps:
1) manually entering into said facsimile machine a code corresponding to a telephone number or partial telephone number to be added to said listing; or
2) manually entering into said facsimile machine a telephone number or partial telephone number to be added to said listing; or
3) causing said facsimile machine to scan machine readable data corresponding to a telephone number or partial telephone number to be added to said listing; or
4) manually selecting a telephone number or partial telephone number, or information corresponding to a telephone number or partial telephone number, displayed on a graphical display unit of said facsimile machine; or
5) sending an in-process signal while said facsimile machine is in the process of receiving or printing a facsimile from a sender, wherein said in-process signal causes a telephone number or partial telephone number of said sender to be added to said listing.

28. A facsimile machine for blocking unwanted facsimile transmissions comprising:
receiving means for receiving a transmission from a potential transmitting sender;
memory means for storing at least one listing of telephone numbers or partial telephone numbers corresponding to authorized senders, or unauthorized senders, or both authorized and unauthorized senders; and
a controller which can add telephone numbers or partial telephone numbers to said listing, wherein said telephone numbers or partial telephone numbers can be added by at least one of the following methods:
1) manually entering into said facsimile machine a code corresponding to a telephone number or partial telephone number to be added to said listing; or
2) manually entering into said facsimile machine a telephone number or partial telephone number to be added to said listing; or
3) causing said facsimile machine to scan machine readable data corresponding to a telephone number or partial telephone number to be added to said listing; or
4) manually selecting a telephone number or partial telephone number, or information corresponding to a telephone number or partial telephone number, displayed on a graphical display unit of said facsimile machine; or
5) sending an in-process signal while said facsimile machine is in the process of receiving or printing a facsimile from a sender, wherein said in-process signal causes a telephone number or partial telephone number of said sender to be added to said listing;
wherein said controller is configured to determine whether said potential transmitting sender is an authorized sender or whether said potential transmitting sender is not an authorized sender by referring to said listing, and wherein said controller is configured such that if said transmitting sender is an unauthorized sender or is not an authorized sender, said controller blocks, refuses or terminates the facsimile transmission.

29. The facsimile machine of claim 28 further including incoming facsimile processing means for converting facsimile transmissions into print data, outgoing facsimile processing means for converting data into facsimile transmissions, and print means for printing received facsimile transmissions.

30. A method for selectively blocking facsimile transmissions comprising the steps of:
receiving a proposed facsimile transmission from a sending device coupled to a telephone line;
determining, or attempting to determine, a telephone number of said telephone line; and
if said telephone number of said telephone line cannot be determined, blocking, refusing or terminating the proposed facsimile transmission.

31. The method of claim 30 wherein said receiving, determining and blocking steps are carried out in or by a facsimile machine.

32. The method of claim 31 wherein said blocking, refusing or terminating step includes connecting said facsimile machine to a telephone network and disconnecting said facsimile machine from said telephone network.

33. The method of claim 31 wherein said blocking, refusing or terminating step includes sending a disconnect signal that indicates that a telephone line to which said facsimile machine is coupled is disconnected.

34. The method of claim 30 wherein said blocking, refusing or terminating step includes failing to answer a telephone call from said sending device.

35. The method of claim 30 wherein said determining step includes reviewing a header of said proposed facsimile transmission.

36. The method of claim 30 wherein said determining step includes reviewing information regarding said telephone line, wherein said information is provided by a telephone company.

37. A facsimile machine for selectively blocking facsimile transmissions comprising:
receiving means for receiving a proposed facsimile transmission from a sending device coupled to a telephone line; and
a controller for determining, or attempting to determine, a telephone number of said telephone line and for, if said telephone number of said telephone line cannot be determined, blocking, refusing or terminating the facsimile transmission.

38. The facsimile machine of claim 37 wherein further including incoming facsimile processing means for converting facsimile transmissions into print data, outgoing facsimile processing means for converting data into facsimile transmissions, and print means for printing received facsimile transmissions.

39. A method for blocking unwanted facsimile transmissions comprising the steps of:
compiling at least one listing of partial telephone numbers;
receiving a signal indicative of a facsimile transmission from a potential transmitting sender;
determining whether said potential transmitting sender is an authorized sender or determining whether said potential transmitting sender is not an authorized sender by referring to said listing; and
if said potential transmitting sender is an unauthorized sender or is not an authorized sender, blocking, refusing or terminating the facsimile transmission.

40. The method of claim 39 wherein each of said partial telephone numbers includes a string of numbers, and wherein said determining step includes determining whether said string of numbers is present in a telephone number of said potential transmitting sender.

41. The method of claim 40 wherein said string of numbers is compared to the first part of said telephone number of said potential transmitting sender.

42. The method of claim 41 wherein said first part includes an area code or an area code and exchange.

43. The method of claim 39 wherein each partial telephone number includes a string of numbers and a string of wild card characters.
